(19) United States
(12) Patent Application Publication
(10) Pub. No.: US 2008/0162772 A1
(43) Pub. Date: Jul. 3, 2008

(54) Portable memory device with auto-play audio

(76) Inventors: Chun I. Yeh, Shenzhen City (CN); Jeffrey M. Morris, Buffalo Grove, IL (US)

Correspondence Address: RYNDAK & SURI LLP, 200 W. MADISON STREET, SUITE 2100, CHICAGO, IL, 60606, US

(21) Appl. No.: 11/648,922

(22) Filed: Jan. 3, 2007

(51) Int. Cl. G06F 13/14

(52) U.S. Cl. 710/313

(57) ABSTRACT

A USB flash memory device is provided which automatically plays pre-recorded audio when the device is inserted into a USB port of a personal computer. The housing of the memory device may be imprinted with promotional information. The pre-recorded audio may include a promotional message, a message relating to a sweepstakes or other contest or any other information. The memory device includes a sound chip which includes its own memory that stores the pre-recorded message. The sound chip of the memory device may be pre-recorded in mass, or optionally an end-user may record its own personal message. Power to the memory device is supplied by the personal computer.

### FIELD OF THE INVENTION

The present invention relates to flash memory drives and more particularly to a USB flash memory device which automatically plays prerecorded audio when the memory device is inserted into a USB port of a personal computer.

### BACKGROUND OF THE INVENTION

Flash memory cards have become widely used due to their small physical size, large memory capacity, easy portability, high reliability, fast access speed and increasingly lower cost. In particular, USB memory sticks, also called USB flash drives, thumb drives, and pen drives (for their shape resembling a writing pen), are used for transporting data between personal computers (“PC's”). They are NAND-type flash memory storage devices integrated with a USB (Universal Serial Bus) interface. They are small, lightweight, removable, portable and rewritable. A USB memory stick has electronic components mounted on a printed circuit board encased in a plastic or metal housing, with a USB connector protruding from one end. A removable cap is often provided to protect the connector, reduce the risk of damage caused by static electricity, and enhance the appearance of the memory stick. The housing may have an aperture to permit attachment of the memory stick to a keychain or lanyard.

The USB memory stick is simply inserted into an available USB port on a PC, and the operating system of the PC recognizes it as a device, e.g., a disk drive. The user may then access files stored on the memory stick, copy them to a hard drive of the PC, and copy files from the hard drive of the PC to the memory stick.

USB memory sticks have also become popular promotional items of the type given by businesses to customers and prospective customers, for example, at trade shows. The housing of the memory sticks can be imprinted with the business's name, logo, contact information and/or a promotional message. Since the USB memory stick is a useful device, the recipient is likely to keep it and use it on a regular basis, and each time he uses it will see the promotional message and be reminded of the business.

Of course, some users will not necessarily pay attention to a printed promotional message. A need therefore exists for an improved USB memory device which will capture and hold the user's attention.

In addition, a need exists for a USB memory device that will stand out from other promotional items and provide a promotional message to a user in a memorable fashion.

### BRIEF SUMMARY OF THE INVENTION

In accordance with one aspect of the present invention, a portable data storage device comprises a connective port electrically connectable to a host machine, whereby the host machine provides power to the portable data storage device, a non-volatile memory unit, a sound transducer and a sound unit for storing audio content and playing the audio through the sound transducer when the connective port is connected to the host machine.

In one embodiment of the present invention, the non-volatile memory of the portable data storage is flash memory.

In one embodiment of the present invention, the connective port is a USB port.

In accordance with another aspect of the present invention, the audio content is a promotional message.

In accordance with another aspect of the present invention, a portable USB flash memory device contains a prerecorded audio promotional message and automatically plays the message when inserted into the USB port of a computer.

In another aspect of the invention, a method for playing audio content from a portable data storage device, comprises providing a portable data storage device having a connective port electrically connectable to a host machine whereby the host machine provides power to the portable data storage device, a non-volatile memory unit, a memory controller for controlling the transfer of data between the non-volatile memory and the host machine via the connective port, a sound transducer, and a sound unit; storing audio content in the sound unit; and automatically playing the audio content from the sound unit through the sound transducer when the connective port is connected to the host machine.

### BRIEF DESCRIPTION OF THE SEVERAL VIEWS OF THE DRAWINGS

FIG. 1 is a top view of one embodiment of a USB memory stick in accordance with the invention;

FIG. 2 is an exploded perspective view of the housing for a USB memory stick in accordance with the invention;

FIG. 3A is a top view of a printed circuit board showing the primary electronic components of one embodiment of a USB memory stick in accordance with the invention;

FIG. 3B is a bottom view of a printed circuit board of one embodiment of a USB memory stick in accordance with the invention; and

FIG. 4 is a schematic diagram of an exemplary audio circuit of a USB memory stick with an auto-play audio capability in accordance with the invention.

### DETAILED DESCRIPTION OF THE INVENTION

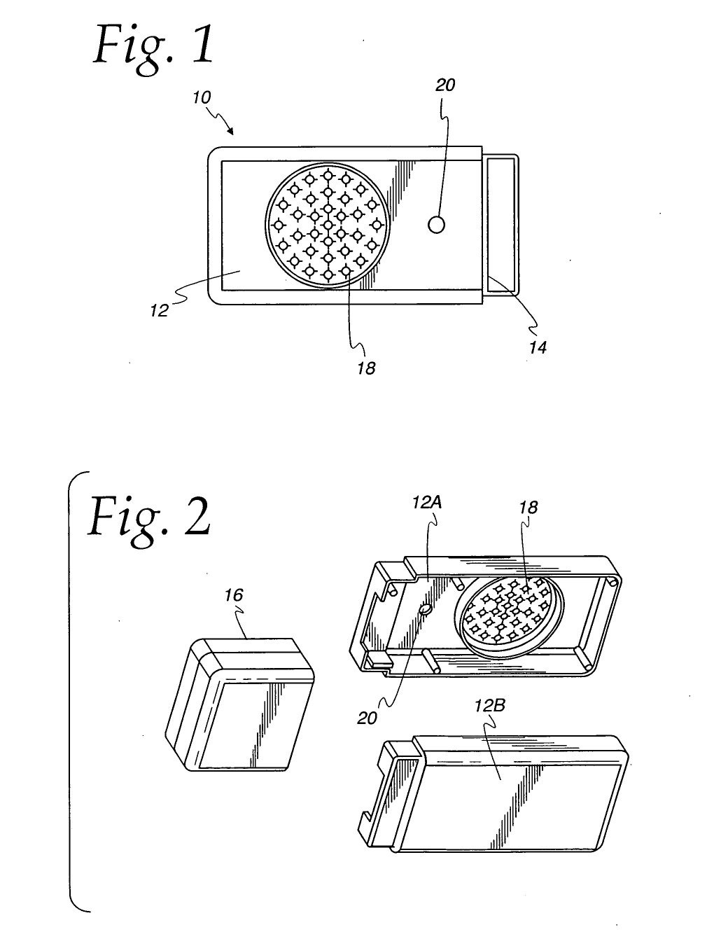

Referring to FIGS. 1 and 2, a memory stick 10 includes a housing 12 and a USB connector 14. In the exemplary embodiment shown, housing 12 is formed in two parts, a top portion 12A and a bottom portion 12B, which are assembled together to form completed housing 12. USB connector 14 is preferably a standard male type-A USB 2.0 connector which is compatible with USB 2.0 ports on most PC's. Preferably a cover 16 is provided for USB connector 14 to protect USB connector 14 when not connected to a USB port. Alternately, USB connector 14 may be retractable into housing 12 when not in use.

Top portion 12A is provided on one side with a speaker grill 18, which permits sound from a speaker mounted inside housing 12 to be audible to a user. An LED aperture 20 is also provided in housing 12.

Housing 12 and cover 16 are preferably made of rigid plastic, but may also be made of metal or another suitable material. The dimensions of housing 12 are preferably about 60 mm long by 25 mm wide by 10 mm high, but the exact dimensions and shape are not critical and may be varied as desired for aesthetics and convenience. Housing 12 and/or cover 16 may be printed with decorative designs, a company logo, a promotional message or other indicia.

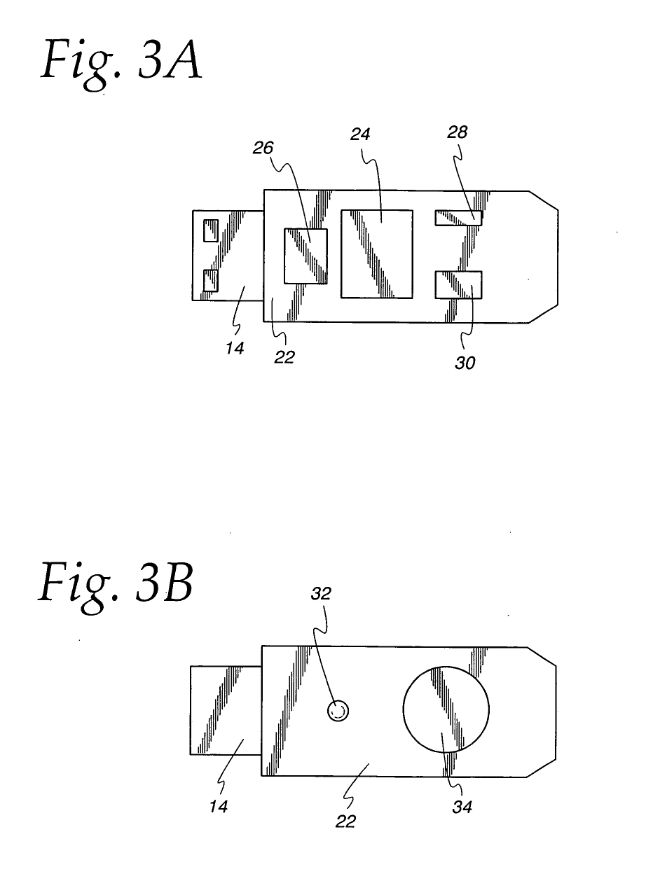

As shown in FIG. 3, the electronic components of the device are preferably mounted on a printed circuit board 22 which is sized and shaped to fit inside housing 12. Referring to FIG. 3A, the principal electronic components are a flash memory device 24, a USB controller 26, a crystal oscillator 28, and a sound chip 30, which are mounted on one side of printed circuit board 22. An LED 32 and a speaker 34 are mounted on the other side of printed circuit board 22 and are positioned in housing 12 in proximity to and alignment with LED aperture 20 and speaker grill 18, respectively. Of course, the exact layout of the components on printed circuit board 22 may be varied depending on the exact components selected and other factors.

NAND flash memories suitable for use in a USB memory stick are currently available in a range of memory capacities from about 64 MB to about 64 GB. An example of a suitable flash memory device is the HY27UF081G2M 1 GB flash memory from Hynix Semiconductor, Inc., but any flash memory device of the desired memory capacity may be selected.

Flash memory controllers typically include a small microprocessor and a small amount of on-chip ROM and RAM. The ROM contains the instructions for operating the controller. A suitable controller is the UB6210 Pen Drive Controller available from ENE Technology Inc. The UB6210 is a USB 2.0 mass storage class device controller designed for mapping NAND-type flash memories to disk for easy access. It is capable of operating at high speed (480 Mb/s). The UB6210 is available in a 48-pin surface mount package.

Flash memory device 24, USB controller 26 and oscillator 28 are connected as known in the art and operate as known in the art to provide a full-function memory stick, which may be used, for example, to transport data files conveniently between computers. That is, USB controller 26 controls all data read and write operations from and to flash memory 24, permitting data to be transferred quickly and easily between memory stick 10 and the user's computer. LED 32 is illuminated by controller 26 to indicate data transfers or data reads and writes.

Crystal oscillator 28 produces a clock signal for the memory stick circuit. Typically, the clock is 12 MHz and controls the memory stick's data output through a phase locked loop (PLL).

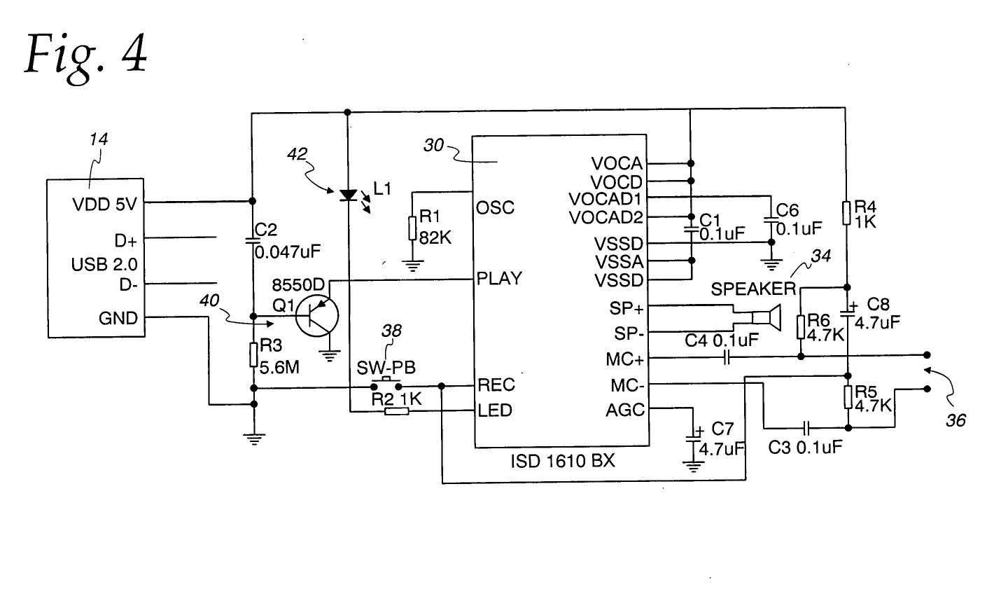

The audio feature of memory stick 10 is provided by a sound unit having a circuit such as that shown in the schematic of FIG. 4. Sound chip 30 is an integrated circuit with onboard memory and record and playback capabilities, such as the ISD 1610 BX. Speaker 34 is connected to the audio outputs (SP+ and SP−) of sound chip 30. Sound chip 30 is connected to power and ground and to various discrete resistors and capacitors as shown in FIG. 4 and as known in the art for proper operation of the circuit.

The desired audio, such as for example a promotional message or a message related to a sweepstakes or contest, is recorded and stored in sound chip 30. Typically, the pre-recorded message is simply recorded into onboard memory in sound chip 30 from an external audio source, such as a CD player, computer, etc., which is connected to the recording inputs (MIC+ and MIC−) of sound chip 30 at audio input terminals 36. The recording function is activated by closing a record switch 38 which is connected to the REC pin of sound chip 30. Alternately, sound chip 30 may be prerecorded before being installed in memory stick 10. This would facilitate mass recording of sound chips for production of numerous memory sticks with the same message. The audio content may include music, a spoken message, sound effects, or a combination thereof as desired. Optionally, a small microphone (not shown) may be included in memory stick 10 and connected to the MIC+ and MIC− inputs of sound chip 30 via audio input terminals 36 to permit a user to record custom messages by pressing record switch 38 (e.g., through a small aperture in housing 12) and speaking into the microphone (also through a small aperture in housing 12). Alternately, speaker 34 may also function as a microphone as is known in the art to provide a recording input. LED 40 is connected to the LED pin of sound chip 30 and may be illuminated to indicate that sound chip 30 is in the record mode.

Sound chip 30 may include an analog-to-digital (A/D) converter for converting analog signals from audio input terminals 36 to digital form, memory for storing the digitized audio, a digital-to-analog (D/A) converter for converting the stored digitized audio back to an analog signal, an amplifier for amplifying the analog signal from the D/A converter, and an audio output for outputting the amplified analog signal to speaker 34.

Memory stick 10 does not have a battery or other on-board power source, and requires no other external power source. Instead, it obtains its operating voltages from the computer via the USB port of the computer (or a USB hub connected to one or more computers). Flash memory is non-volatile, i.e., does not require power to retain the contents of the memory. Standard components necessary for providing and distributing the operating voltages required by flash memory device 24, controller 26, sound chip 30 and the other components are provided on printed circuit board 22 as is known in the art.

The operation of the memory stick is briefly described with reference to FIG. 4. The user inserts USB connector 14 into a USB port on a computer or USB hub. Power from the USB port is immediately supplied via USB connector 14 to sound chip 30 (via its V_{CC} and V_{SS} pins) and transistor 42, which turns on and sends a signal to the PLAY input on sound chip 30. This initiates playback of the recorded audio through speaker 34. Audio playback begins without the need for the computer's operating system to recognize the memory stick as a drive and without the user taking any action. Because memory stick 10 includes on-board speaker 34, it is not necessary for the user's computer to have its own speaker or any audio capabilities. If desired, a switch may be provided to permit the user to disable playback of the message.

The computer's operating system will also recognize the memory stick as a disk drive and prompt the user for instructions as to what the user wishes to do, e.g., open a folder to view the files in the flash memory, copy files to or from flash memory device 24, etc. Thus, after playing the prerecorded audio message, memory stick 10 functions as a standard USB memory device.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

What is claimed is:

1. A portable data storage device, comprising:
a connective port electrically connectable to a host machine, whereby the host machine provides power to the portable data storage device;
a non-volatile memory unit;
a memory controller for controlling the transfer of data between the non-volatile memory and the host machine via the connective port;
a sound transducer; and
a sound unit for storing recorded audio content and playing the stored audio content through the sound transducer when the connective port is connected to the host machine.

2. The portable data storage device of claim 1 wherein the connective port is a USB port.

3. The portable data storage device of claim 1 wherein the non-volatile memory comprises flash memory.

4. The portable data storage device of claim 1 wherein the audio content comprises a promotional message.

5. The portable data storage device of claim 1 wherein the audio content comprises a message related to a sweepstakes or contest.

6. The portable data storage device of claim 1 wherein the sound transducer is a loudspeaker.

7. The portable data storage device of claim 1 wherein the sound transducer functions both as a speaker for playing the audio content from the sound unit and a microphone for recording audio content to the sound unit.

8. The portable data storage device of claim 1 wherein the sound unit comprises an analog audio input, an A/D converter for converting analog signals from the analog audio input to digital form, memory for storing the digitized audio, a D/A converter for converting the stored digitized audio to an analog signal, an amplifier for amplifying the analog signal from the D/A converter, and an audio output for outputting the amplified analog signal to the sound transducer.

9. The portable data storage device of claim 1 further comprising user-activated means for disabling playing the audio content.

10. A portable data storage device, comprising:
a housing;
a circuit board mounted inside the housing;
a connective port connected to the circuit board and extending from the housing, the port being electrically connectable to a host machine, whereby the host machine provides power to the portable data storage device;
a non-volatile memory unit mounted on the circuit board;
a memory controller mounted on the circuit board for controlling the transfer of data between the non-volatile memory and the host machine via the connective port;
a loudspeaker; and
a sound unit mounted on the circuit board for storing recorded audio content and playing the stored audio content through the speaker when the port is connected to the host machine.

11. The portable data storage device of claim 10 wherein the port is a USB port.

12. The portable data storage device of claim 10 wherein the non-volatile memory comprises flash memory.

13. The portable data storage device of claim 10 wherein the audio content comprises a promotional message.

14. The portable data storage device of claim 10 wherein the audio content comprises a message related to a sweepstakes or contest.

15. The portable data storage device of claim 10 further comprising an LED which is illuminated when data is being transferred between the portable data storage device and the host machine.

16. A method for playing audio content from a portable data storage device, comprising:
providing a portable data storage device having a connective port electrically connectable to a host machine whereby the host machine provides power to the portable data storage device, a non-volatile memory unit, a memory controller for controlling the transfer of data between the non-volatile memory and the host machine via the connective port, a sound transducer, and a sound unit;
storing audio content in the sound unit; and
automatically playing the audio content from the sound unit through the sound transducer when the connective port is connected to the host machine.

17. The method of claim 16 wherein the connective port is a USB connector.

18. The method of claim 16 wherein the non-volatile memory unit comprises flash memory.

19. The method of claim 16 wherein the audio content comprises a promotional message.

20. The method of claim 16 wherein the audio content comprises a message related to a sweepstakes or contest.
